(19) United States
(12) Patent Application Publication
(10) Pub. No.: US 2021/0165654 A1
(43) Pub. Date: Jun. 3, 2021

(54) ELIMINATING EXECUTION OF INSTRUCTIONS THAT PRODUCE A CONSTANT RESULT

(71) Applicant: Marvell International Ltd., Hamilton (BM)

(72) Inventor: David CARLSON, Haslett, TX (US)

(21) Appl. No.: 16/702,446

(22) Filed: Dec. 3, 2019

(51) Int. Cl. G06F 9/30; G06F 9/38

(52) U.S. Cl. CPC G06F 9/3001; G06F 9/3867

(57) ABSTRACT

An instruction is received by a processing pipeline of a computer processor. The instruction is a constant-type of instruction and has an associated constant value. A constant register file is assigned to the instruction. The constant value is written to the constant register file without sending the instruction to execution units (e.g., arithmetic logic units) in the processor pipeline.

### BACKGROUND

To execute an instruction in a computer system, the instruction is loaded from memory, and a physical register (which can be referred to as the destination register) is assigned to hold the result of executing the instruction. The instruction is executed by an execution unit (e.g., an arithmetic logic unit, ALU) in a processing pipeline, and the result is produced and written to the destination register, where the result is available for other instructions that use it.

There are instances in which a constant value needs to be generated for use in another calculation. One way to generate a constant is to assemble it with an instruction. An Advanced Reduced Instruction Set Computer (RISC) Machine (ARM) architecture includes instructions to facilitate generating constants. There is a class of ARM instructions that produce a result that can be computed solely by knowledge of the instruction. This class of instructions does not read from or write to memory, and does not require as input the results of any other instructions. That is, the instructions have zero input operands. For example, ARM uses what is known as immediate value encoding, where a constant value or piece of data is stored as part of the instruction itself. Like other instructions, this class of instructions is executed by the ALUs in the processing pipeline.

### SUMMARY

Embodiments according to the present invention eliminate execution of the class of instructions described above. As such, the ALUs are available for other processing tasks. This in turn conserves bandwidth and reduces the number of execution conflicts. Implementation of the present invention can result in a one-to-two percent improvement in performance.

In embodiments, a portion of the pool of physical registers is dedicated to holding constants. For example, in a processor that has 128 physical registers, 16 of those registers are dedicated to holding constants. The registers dedicated to holding constants are referred to herein as constant registers.

When an instruction is decoded, if the instruction is a constant-type of instruction, then the instruction is identified as one that produces a constant. In embodiments according to the invention, a constant-type of instruction has zero input operands, one destination operand, and no effect on the condition code register, does not read from memory, does not write to memory, and does not require as input a result from another instruction. In that case, in a mapping step (in which an architectural register is assigned to a physical register), the destination register for that instruction is selected from the pool of constant registers. After this mapping, that instruction is not sent to any of the execution units (e.g., ALUs). That is, the instruction bypasses the ALUs. Instead, after the value of the constant is determined, that value and the number that identifies the destination register are used and the constant is written into the constant register.

These and other objects and advantages of the various embodiments according to the present invention will be recognized by those of ordinary skill in the art after reading the following detailed description of the embodiments that are illustrated in the various drawing figures.

This summary contains, by necessity, simplifications, generalizations, and omissions of detail; consequently, those skilled in the art will appreciate that this summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF DRAWINGS

The accompanying drawings, which are incorporated in and form a part of this specification and in which like numerals depict like elements, illustrate embodiments according to the present invention and, together with the detailed description, serve to explain the principles of the invention.

FIG. 1 is a block diagram illustrating an example of a computing system platform upon which embodiments according to the present invention can be implemented.

FIG. 2 is a block diagram illustrating examples of operations for handling instructions in embodiments according to the present invention.

FIG. 3 is a flowchart of examples of operations in computer-implemented methods for handling instructions in embodiments according to the present invention.

### DETAILED DESCRIPTION

Reference will now be made in detail to the various embodiments according to the present invention, examples of which are illustrated in the accompanying drawings. While described in conjunction with these embodiments, it will be understood that they are not intended to limit the invention to these embodiments. On the contrary, the disclosure is intended to cover alternatives, modifications and equivalents, which may be included within the spirit and scope of the disclosure as defined by the appended claims.

Furthermore, in the following detailed description of the present invention, numerous specific details are set forth in order to provide a thorough understanding of the present invention. However, it will be understood that the present invention may be practiced without these specific details. In other instances, well-known methods, procedures, components, and circuits have not been described in detail so as not to unnecessarily obscure aspects of the present invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computing system. It has proven convenient at times, principally for reasons of common usage, to refer to these signals as transactions, bits, values, elements, symbols, characters, samples, pixels, or the like.

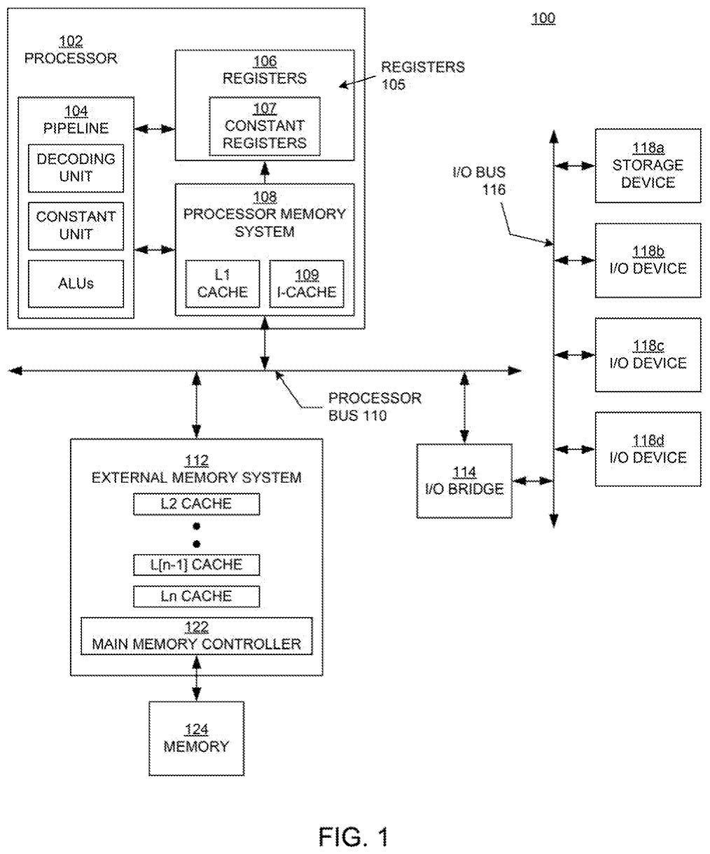

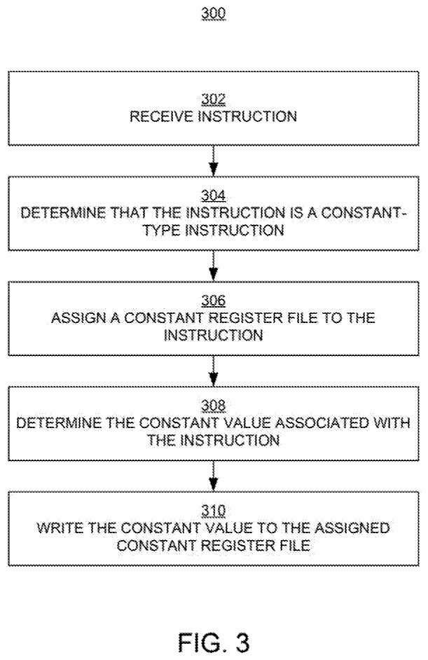

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “sending,” “generating,” “determining,” “accessing,” “writing,” “reading,” “computing,” “processing,” “loading,” “storing,” “identifying,” “producing,” “mapping,” “assigning,” “detecting,” “providing,” or the like, refer to actions and processes (e.g., the flowchart 300 of FIG. 3) of a computing system or similar electronic computing device or processor (e.g., the computing system 100 of FIG. 1). A computing system or similar electronic computing device manipulates and transforms data represented as physical (electronic) quantities within the computing system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), dynamic RAM, (DRAM), caches, read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram illustrating an example of a computing system 100 upon which embodiments according to the present invention can be implemented. Embodiments according to the present invention are not limited to a platform like that of the computing system 100.

The system 100 includes at least one processor 102, which can be a single central processing unit (CPU) or one of multiple processor cores of a multi-core architecture. In the FIG. 1 example, the processor 102 includes a processing pipeline 104, a set of physical register files (or registers) 105, and a processor memory system 108. In an embodiment, the processor 102 is an Advanced Reduced Instruction Set Computer (RISC) Machine (ARM) processor.

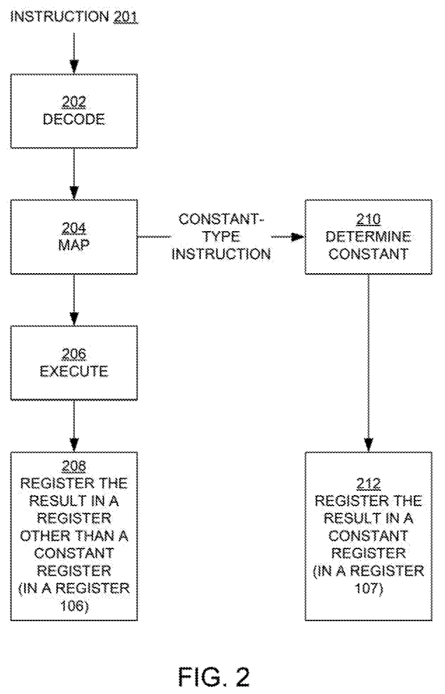

The processing pipeline 104 includes a decoding unit that decodes an incoming instruction, one or more execution units (e.g., arithmetic logic units, ALUs) that execute instructions, and a constant unit that determines a constant value associated with an instruction. Additional details are provided below in the discussion of FIG. 2. The processing pipeline 104 can include other components known in the art and that do not need to be further described herein.

Continuing with reference to FIG. 1, each of the registers 105 is uniquely identified by a respective register number. In embodiments, the set of registers 105 includes a pool of registers 107 that are dedicated to holding constants; these registers are referred to herein as constant registers. The registers in the set of registers 105 that are not dedicated to holding constants are identified herein simply as the registers 106. In one such embodiment, the set registers 105 includes 128 registers in total, and the pool of constant registers 107 includes 16 registers. Each of the constant registers 107 is used to hold a respective constant value; additional details are provided in conjunction with FIGS. 2 and 3, which are below.

The processor 102 of FIG. 1 is connected to a processor bus 110, which enables communication with an external memory system 112 and an input/output (I/O) bridge 114. The I/O bridge 114 enables communication over an I/O bus 116 with various different I/O devices including, for example, a storage device 118a and other I/O devices 118b, 118c, and 118d (e.g., a network interface, display adapter, and/or user input devices such as a keyboard or mouse). The storage device 118a, such as a disk drive or other large capacity (typically non-volatile) storage device, can also serve as secondary storage for the main memory 124.

In the FIG. 1 example, the external memory system 112 includes a main memory controller 122, which is connected to any number of memory modules (e.g., dynamic random access memory, DRAM, modules) that serve as the main memory 124.

In the example computing system 100, the processor memory system 108 and the external memory system 112 together form a hierarchical cache system, including at least a first level (L1) cache within the processor memory system, and any number of “higher-level” caches (L2, . . . , Ln) within the external memory system. The “highest-level” cache within the external memory system 112 (which may be the L2 cache if there are only two levels in the hierarchy) is the Ln cache, which is located closer to the memory module (main memory) 124—and furthest from the processor 102—than the other caches (L2, . . . , L[n−1]). The caches L1-Ln may be referred to as data caches. The distribution of caches within the processor memory system 108 and the external memory system 112 may be different in other implementations. The processor memory system 108 also includes an instruction cache (I-cache) 109.

In operation, instructions from the instruction cache 109 are loaded into the processing pipeline 104, where they are decoded, assigned respective destination registers, and optionally executed in execution units (e.g., ALUs). As will be described, in embodiments according to the present invention, a class of instructions is not sent to the ALUs; that is, those instructions bypass the ALUs.

In embodiments, the class of instructions that are not sent to the ALUs includes instructions with zero operands. More specifically, the class of instructions includes instructions that may be an arithmetic instruction or a flow control instruction and have all of the following characteristics: zero input operands, one destination operand, and no effect on the condition code (CC) register (e.g., a bit value or flag in the CC register is not changed: a bit is not set or cleared). The CC register may instead be known as the application program status register, and may be generally known as a status register or flag register. This class of instructions also does not read from or write to memory, and also does not require as input the results of any other instructions. This class of instructions is referred to herein as a constant-type of instruction or simply a constant-type instruction. In an ARM embodiment, this class of instructions includes, but is not limited to, the following instructions:

ORR xd, xzr, #<imm>;

MOVN xd, #<imm>, {LSL #<shift>};

MOVZ xd, #<imm>, {LSL #<shift>};

ADR xd;

ADRP xd; and

BL<label>.

The ORR, MOVN, MOVZ, ADR, and ADRP instructions are arithmetic instructions, and the BL instruction is considered a flow control instruction.

The ORR instruction is a bitwise inclusive instruction. The MOVN instruction is to move wide with NOT. The MOVZ instruction is to move wide with zero. The ADR instruction adds a signed immediate value to the value of the program counter that fetched the instruction. The program counter is a counter that points to the memory location that stores the current instruction or a future instruction. The ADRP instruction permits the calculation of an address at a four kilobyte (4 KB) aligned memory region. The BL instruction writes the address of the sequentially following instruction to a general purpose register (e.g., the register X30 in the ARM processor).

In overview, in embodiments according to the present invention, when an instruction is decoded, if the instruction is a constant-type of instruction as defined above, then the instruction is identified as one that produces a constant. In that case, in a mapping step, in which an architectural register is assigned to a physical register, the destination register for the constant-type instruction is selected from the pool of constant registers 107. After this mapping, the constant-type instruction is not sent to any of the execution units (e.g., ALUs). Instead, after the value of the constant is determined, that value and the number that identifies the destination register are used and the constant is written into the constant register.

FIG. 2 is a block diagram illustrating an example of operations that can be performed in the processing pipeline 104 to handle instructions in embodiments according to the present invention.

In the example of FIG. 2, an instruction 201 is fetched from memory (e.g., from the instruction cache 109 of FIG. 1). In block 202, the instruction is decoded in a decoder unit of the processing pipeline 104.

In block 202, the decoder unit determines whether or not the instruction 201 is a constant-type instruction. In an embodiment, a bit can be set to identify a constant-type instruction.

Block 204 is a mapping stage, in which an architectural register associated with the instruction 201 is assigned to one of the physical registers 105 (FIG. 1). The selected register can be referred to as the destination register. If the instruction 201 is not identified as a constant-type instruction, then the destination register is one of the registers 106 (FIG. 1). If the instruction 201 is identified as a constant-type instruction, then the destination register is one of the constant registers 107 (FIG. 1).

If the instruction 201 is not identified as a constant-type instruction, then the instruction is sent to an execution unit (e.g., an ALU) in the processing pipeline 104 (block 206 of FIG. 2). The result of executing the instruction in block 206 is written to one of the registers 106 (block 208); that is, the result is written to a register other than one of the constant registers 107.

If the instruction 201 is identified as a constant-type instruction, then the instruction is sent to a constant unit in the processing pipeline 104. That is, the constant-type instruction bypasses the execution block 206 in the processing pipeline 104. In an embodiment, the constant unit uses the operation code (opcode) in the instruction 201, and the program counter value associated with the instruction, to determine the value of the constant associated with the instruction (block 210). The constant value is then written to one of the constant registers 107 (block 212).

In embodiments, in the mapping stage (block 204), it is first determined whether one of the constant registers 107 is available before a destination address is assigned for the result of a constant-type instruction. If one of the constant registers 107 is not available, then the constant-type instruction can be sent to an execution unit that will use a general purpose register as a destination.

In embodiments, to determine whether one of the constant registers 107 is available, a list of free registers that includes only the constant registers 107 is maintained. That is, in these embodiments, there are at least two separate lists that identify free registers: one list identifies which of the registers 106 are free, and another list separately identifies which of the constant registers 107 are free. The list of free constant registers 107 can be accessed by the processing pipeline 104 (e.g., during the mapping stage), and any free constant registers can be added to the mapping table used in the mapping stage (block 204).

In embodiments, the number of constant-type instructions that bypass the execution block 206 in the processing pipeline 104 per cycle depends on the number of write ports. For example, if there is only one write port, then only one constant-type instruction per cycle is handled as described above.

FIG. 3 is a flowchart 300 of examples of operations in computer-implemented methods for in embodiments according to the present invention. The operations in the flowchart 300 can be performed in and by the computing system 100 of FIG. 1, for example, although embodiments according to the present invention are not limited to that type of system. The operations in the flowchart 300 do not necessarily need to be performed in the order in which they are shown and described, and may be performed in conjunction with other known instructions for processing computer-implemented instructions. FIG. 3 is discussed with reference also to elements of FIGS. 1 and 2.

In block 302, an instruction 201 is received by a processing pipeline 104 of a computer processor 102.

In block 304, a determination is made that the instruction 201 is a constant-type of instruction as defined above and a constant value associated therewith. In an embodiment, to determine whether the instruction 201 is a constant-type instruction, the value of a bit is detected, and the value of the bit indicates whether the instruction is a constant-type instruction (e.g., if the bit is set, then the instruction is a constant-type instruction).

In block 306, a constant register file (one of the registers 107) is assigned to the instruction 201. In embodiments, before the constant register file is assigned, a determination is made as to whether one of the registers 107 is available, as described above.

In block 308, the value of the constant associated with the constant-type instruction is determined. For example, the instruction can include an opcode, and the value of the constant can be determined using the opcode and a program counter value for the instruction.

In block 310, the constant value is written to the assigned constant register file 107, thereby bypassing ALUs in the processor pipeline 104.

Embodiments according to the present invention eliminate execution of the class of instructions described above. As such, the ALUs are available for other processing tasks. This in turn conserves bandwidth and reduces the number of execution conflicts. Implementation of the present invention can result in a one-to-two percent improvement in performance.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The example methods described and/or illustrated herein may also omit one or more of the steps described or illustrated herein or include additional steps in addition to those disclosed.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

Although the subject matter has been described in language specific to structural features and/or methodological acts, it is to be understood that the subject matter defined in the disclosure is not necessarily limited to the specific features or acts described above. Rather, the specific features and acts described above are disclosed as example forms of implementing the present invention.

Embodiments according to the invention are thus described. While the present invention has been described in particular embodiments, it should be appreciated that the invention should not be construed as limited by such embodiments, but rather construed according to the following claims.

What is claimed is:

1. A computer-implemented method, comprising:
receiving an instruction by a processing pipeline of a computer processor, wherein the instruction is a constant-type of instruction that has a constant value associated therewith;
assigning a constant register file to the instruction; and
writing the constant value to the constant register file, said writing bypassing arithmetic logic units in the processor pipeline.

2. The method of claim 1, wherein the constant-type of instruction is a reduced instruction set computer (RISC) instruction selected from the group consisting of: an ADR instruction; an ADRP instruction; a BL instruction; an ORR instruction; an MOVZ instruction; and an MOVN instruction.

3. The method of claim 1, wherein the constant-type of instruction comprises an instruction that has zero input operands, one destination operand, and no effect on the condition code register, does not read from memory, does not write to memory, and does not require as input a result from another instruction.

4. The method of claim 1, further comprising determining that the instruction is the constant-type of instruction.

5. The method of claim 4, wherein said determining comprises detecting a value of a bit, wherein the value of the bit indicates whether the instruction is the constant-type of instruction.

6. The method of claim 1, further comprising determining whether the constant register file is available prior to said assigning.

7. The method of claim 1, wherein the instruction comprises an opcode, wherein the method further comprises determining the constant value using the opcode and a program counter value for the instruction.

8. A system, comprising:
a processor comprising a processing pipeline comprising an execution unit, the processor further comprising a plurality of register files and an instruction cache; and
a memory coupled to the processor;
wherein the processor is operable for executing instructions that, when executed, perform operations comprising:
receiving an instruction into the processing pipeline, wherein the instruction is a constant-type of instruction that has a constant value associated therewith;
assigning a constant register file of the plurality of register files to the instruction; and
writing the constant value to the constant register file, said writing bypassing the execution unit.

9. The system of claim 8, wherein the constant-type of instruction is a reduced instruction set computer (RISC) instruction selected from the group consisting of: an ADR instruction; an ADRP instruction; a BL instruction; an ORR instruction; an MOVZ instruction; and an MOVN instruction.

10. The system of claim 8, wherein the constant-type of instruction comprises an instruction that has zero input operands, one destination operand, and no effect on the condition code register, does not read from memory, does not write to memory, and does not require as input a result from another instruction.

11. The system of claim 8, wherein the operations further comprise determining that the instruction is the constant-type of instruction.

12. The system of claim 11, wherein the operations further comprise detecting a value of a bit, wherein the value of the bit determines whether the instruction is the constant-type of instruction.

13. The system of claim 8, wherein the operations further comprise determining whether the constant register file is available prior to said assigning.

14. The system of claim 8, wherein the instruction comprises an opcode, wherein the operations further comprise determining the constant value using the opcode and a program counter value for the instruction.

15. A system, comprising:
means for providing an instruction to a processing pipeline of a computer processor, wherein the instruction is a constant-type of instruction that has a constant value associated therewith, wherein the constant-type of instruction comprises an instruction that has zero input operands, one destination operand, and no effect on the condition code register, does not read from memory, does not write to memory, and does not require as input a result from another instruction;
means for assigning a constant register file to the instruction; and
means for writing the constant value to the constant register file without sending the instruction to arithmetic logic units in the processor pipeline.

16. The system of claim 15, wherein the constant-type instruction is a reduced instruction set computer (RISC) instruction selected from the group consisting of: an ADR instruction; an ADRP instruction; a BL instruction; an ORR instruction; an MOVZ instruction; and an MOVN instruction.

17. The system of claim 15, further comprising means for determining that the instruction is the constant-type of instruction.

18. The system of claim 17, further comprising means for detecting a value of a bit, wherein the value of the bit indicates whether the instruction is the constant-type of instruction.

19. The system of claim 15, further comprising means for determining whether the constant register file is available prior to said assigning.

20. The system of claim 15, wherein the instruction comprises an opcode, the system further comprising means for determining the constant value using the opcode and a program counter value for the instruction.
